(19) United States
(12) Patent Application Publication
(10) Pub. No.: US 2025/0122598 A1
(43) Pub. Date: Apr. 17, 2025

(54) HIGH STRENGTH ALUMINIUM ALLOYS CONTAINING SILICON, COPPER, AND BORON FOR USE IN ADDITIVE MANUFACTURING

(71) Applicant: Technology Innovation Institute - Sole Proprietorship LLC, Masdar City (AE)

(72) Inventors: Federico Bosio, Abu Dhabi (AE); Giuseppe Del Guercio, Abu Dhabi (AE); Chinmay Phutela, Abu Dhabi (AE); Abdulla AlShehhi, Abu Dhabi (AE); Monserrat Gutierrez Munoz, Abu Dhabi (AE); Nesma T. Aboulkhair, Abu Dhabi (AE)

(73) Assignee: Technology Innovation Institute - Sole Proprietorship LLC, Masdar City (AE)

(21) Appl. No.: 18/912,873

(22) Filed: Oct. 11, 2024

Related U.S. Application Data
(60) Provisional application No. 63/590,042, filed on Oct. 13, 2023.

(51) Int. Cl. C22C 21/02; B22F 1/00; B22F 1/05; B22F 10/28; B33Y 10/00; B33Y 70/00; B33Y 80/00

(52) U.S. Cl. CPC C22C 21/02; B22F 1/05; B22F 1/09; B22F 10/28; B33Y 10/00; B33Y 70/00; B33Y 80/00

(57) ABSTRACT

The present disclosure describes an alloy which achieves a level of densification of 99.2% or greater and a method of making the same, wherein the method may include (a) depositing a first layer of a precursor powder including aluminum, silicon, copper, and boron onto a build platform, (b) contacting the first layer of the precursor powder with an energy source to form a solid layer, (c) depositing a subsequent layer of the precursor powder on top of the solid layer, (d) contacting the subsequent layer of the precursor powder with the energy source to fuse the subsequent layer of the precursor powder to the solid layer, thereby forming the three-dimensional article.

### CROSS-REFERENCE TO RELATED APPLICATIONS

This application claims priority to U.S. Provisional Patent Application No. 63/590,042, filed on Oct. 13, 2023, which is hereby incorporated by reference herein in its entirety.

### FIELD

The present disclosure relates generally to alloy compositions and methods of making and using the same for additive manufacturing. More specifically, the present disclosure relates to alloy compositions containing silicon, copper, and boron.

### BACKGROUND

Additive manufacturing of metal parts is a powerful alternative to conventional casting routes, thanks to its capability to manufacture complex parts with high design freedom and without the need for further assembly or post-process joining. Additive manufacturing is a strategic technology which allows the opportunity to design novel alloy compositions with specific properties which cannot be generated in conventional processes. Powder Bed Fusion-Laser Beam (PBF-LB) has been previously investigated as an additive manufacturing technique; however, only a limited number of commercially available alloy compositions exist for this technology.

Developing new alloys for additive manufacturing, specifically those for powder bed fusion, is an important challenge to address in the field. The development of new alloys typically requires significant economic investment and research, due to both the cost of starting material powders and the specific particle sizes required to guarantee good flowability and prevent the formation of unwanted porosity.

Achieving a high level of densification during additive manufacturing (that is, limiting void space in the resulting part) is a significant obstacle towards the realization of new alloys, and there are numerous process parameters which can affect the alloy formation process. It is crucial to consider both the composition of the alloy itself and the additive manufacturing process parameters in designing a material which will provide high density of the printed article, excellent tensile properties, and light overall weight, where required. It remains a challenge in the industry to design and prepare such materials, and successful alloy compositions and methods of making the same are of high commercial and industrial value.

### SUMMARY

In some aspects, the techniques described herein relate to a method for forming a three-dimensional article including an alloy, the method including steps of: (a) depositing a first layer of a precursor powder onto a build platform, wherein the precursor powder includes aluminum, silicon, copper, and boron; (b) contacting the first layer of the precursor powder with an energy source to form a solid layer of the alloy; (c) depositing a subsequent layer of the precursor powder on top of the solid layer; and (d) contacting the subsequent layer of the precursor powder with the energy source to fuse the subsequent layer of the precursor powder to the solid layer; thereby forming the three-dimensional article.

In some aspects, the techniques described herein relate to a method, wherein the precursor powder includes greater than or equal to 0.01 wt. % to less than or equal to 1 wt. % boron.

In some aspects, the techniques described herein relate to a method according to any of the above aspects, wherein the precursor powder includes greater than or equal to 4 wt. % to less than or equal to 8 wt. % copper.

In some aspects, the techniques described herein relate to a method according to any of the above aspects, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 1 wt. % boron, and greater than or equal to 75 wt. % to less than or equal to 88 wt. % aluminum.

In some aspects, the techniques described herein relate to a method according to any of the above aspects, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 1 wt. % boron, greater than or equal to 0.01 wt. % to less than or equal to 0.5 wt. % nitrogen, and greater than or equal to 75 wt. % to less than or equal to 88 wt. % aluminum.

In some aspects, the techniques described herein relate to a method according to any of the above aspects, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 1 wt. % boron, greater than or equal to 0.01 wt. % to less than or equal to 0.8 wt. % iron, and greater than or equal to 75 wt. % to less than or equal to 88 wt. % aluminum.

In some aspects, the techniques described herein relate to a method according to any of the above aspects, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 1 wt. % boron, greater than or equal to 0.01 wt. % to less than or equal to 0.6 wt. % manganese, and greater than or equal to 75 wt. % to less than or equal to 88 wt. % aluminum.

In some aspects, the techniques described herein relate to a method according to any of the above aspects, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 1 wt. % boron, greater than or equal to 0.01 wt. % to less than or equal to 0.6 wt. % magnesium, and greater than or equal to 75 wt. % to less than or equal to 88 wt. % aluminum.

In some aspects, the techniques described herein relate to a method according to any of the above aspects, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 1 wt. % boron, greater than or equal to 0.01 wt. % to less than or equal to 0.3 wt. % titanium, and greater than or equal to 75 wt. % to less than or equal to 88 wt. % aluminum.

In some aspects, the techniques described herein relate to a method according to any of the above aspects, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 1 wt. % boron, greater than or equal to 0.01 wt. % to less than or equal to 0.5 wt. % nitrogen, greater than or equal to 0.01 wt. % to less than or equal to 0.8 wt. % iron, greater than or equal to 0.01 wt. % to less than or equal to 0.6 wt. % manganese, greater than or equal to 0.01 wt. % to less than or equal to 0.6 wt. % magnesium, greater than or equal to 0.01 wt. % to less than or equal to 0.3 wt. % titanium, and greater than or equal to 75 wt. % to less than or equal to 88 wt. % aluminum.

In some aspects, the techniques described herein relate to a method according to any of the above aspects, further including preparing the precursor powder, wherein preparing the precursor powder includes combining a copper-containing powder with a silicon-containing powder and boron.

In some aspects, the techniques described herein relate to a method according to any of the above aspects, further including preparing the precursor powder, wherein preparing the precursor powder includes combining boron, an elemental copper powder, and a pre-alloyed powder including silicon and aluminum.

In some aspects, the techniques described herein relate to a method according to any of the above aspects, further including preparing the precursor powder, wherein preparing the precursor powder includes sizing the precursor powder to an average particle size of greater than or equal to 1 μm to less than or equal to 65 μm.

In some aspects, the techniques described herein relate to a method according to any of the above aspects, further including preparing the precursor powder, wherein preparing the precursor powder includes sizing the precursor powder to a particle size distribution of 1 μm to 65 μm.

In some aspects, the techniques described herein relate to a method according to any of the above aspects, further including preparing the precursor powder, wherein preparing the precursor powder includes mixing the precursor powder via ball milling, sizing the precursor powder via vibratory sieving, or a combination thereof.

In some aspects, the techniques described herein relate to a method according to any of the above aspects, further including (e) repeating steps (c) through (d) a plurality of times.

In some aspects, the techniques described herein relate to a method according to any of the above aspects, wherein the three-dimensional article has a density of greater than or equal to 99.2%.

In some aspects, the techniques described herein relate to a method according to any of the above aspects, wherein the three-dimensional article has a density of greater than or equal to 99.5%.

In some aspects, the techniques described herein relate to a method according to any of the above aspects, wherein the three-dimensional article has a density of greater than or equal to 99.9%.

In some aspects, the techniques described herein relate to a method according to any of the above aspects, wherein the alloy has a yield strength of greater than or equal to 200 MPa at 300° C., an ultimate tensile strength of greater than or equal to 250 MPa at 300° C., and a density of greater than or equal to 99.2%.

In some aspects, the techniques described herein relate to a method for producing an alloy structure having a density of greater than or equal to 99.2%, including: providing a precursor powder including greater than or equal to 4 wt. % to less than or equal to 8 wt. % copper and greater than or equal to 0.01 wt. % to less than or equal to 1 wt. % boron to an additive manufacturing system; and contacting the precursor powder with an energy source to form the alloy structure.

In some aspects, the techniques described herein relate to a method, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 1 wt. % boron, and greater than or equal to 75 wt. % to less than or equal to 88 wt. % aluminum.

In some aspects, the techniques described herein relate to a method according to any of the above aspects, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 1 wt. % boron, greater than or equal to 0.01 wt. % to less than or equal to 0.5 wt. % nitrogen, greater than or equal to 0.01 wt. % to less than or equal to 0.8 wt. % iron, greater than or equal to 0.01 wt. % to less than or equal to 0.6 wt. % manganese, greater than or equal to 0.01 wt. % to less than or equal to 0.6 wt. % magnesium, greater than or equal to 0.01 wt. % to less than or equal to 0.3 wt. % titanium, and greater than or equal to 75 wt. % to less than or equal to 88 wt. % aluminum.

In some aspects, the techniques described herein relate to a method according to any of the above aspects, further including sizing the precursor powder via vibratory sieving prior to contacting the precursor powder with an energy source.

In some aspects, the techniques described herein relate to a method according to any of the above aspects, wherein the precursor powder is sized to an average particle size of greater than or equal to 1 μm to less than or equal to 65 μm prior to contacting the precursor powder with the energy source.

In some aspects, the techniques described herein relate to a method according to any of the above aspects, wherein the precursor powder has a particle size distribution of 1 μm to 65 μm.

In some aspects, the techniques described herein relate to a method according to any of the above aspects, wherein providing the precursor powder includes depositing the precursor powder onto a build plate, wherein the build plate is at a temperature of greater than or equal to 100° C. to less than or equal to 300° C.

In some aspects, the techniques described herein relate to a method according to any of the above aspects, wherein contacting the precursor powder with the energy source results in fusing the precursor powder to consolidate the alloy structure, such that the alloy structure has a density of greater than or equal to 99.2%.

In some aspects, the techniques described herein relate to a method according to any of the above aspects, wherein contacting the precursor powder with the energy source results in fusing the precursor powder to consolidate the alloy structure, such that the alloy structure has a density of greater than or equal to 99.5%.

In some aspects, the techniques described herein relate to a method according to any of the above aspects, wherein contacting the precursor powder with the energy source results in fusing the precursor powder to consolidate the alloy structure, such that the alloy structure has a density of greater than or equal to 99.9%.

In some aspects, the techniques described herein relate to a method according to any of the above aspects, wherein contacting the precursor powder with the energy source results in fusing the precursor powder to consolidate the alloy structure, such that the alloy structure has a yield strength of greater than or equal to 200 MPa at 300° C., an ultimate tensile strength of greater than or equal to 250 MPa at 300° C., and a density of greater than or equal to 99.2%.

In some aspects, the techniques described herein relate to a method according to any of the above aspects, wherein contacting the precursor powder with the energy source results in fusing the precursor powder to consolidate the alloy structure, such that the alloy structure has a yield strength of greater than or equal to 200 MPa at 300° C., an ultimate tensile strength of greater than or equal to 250 MPa at 300° C., and a density of greater than or equal to 99.5%.

In some aspects, the techniques described herein relate to an alloy, including: greater than or equal to 4 wt. % to less than or equal to 8 wt. % copper, greater than or equal to 8 wt. % to less than or equal to 11 wt. % silicon, greater than or equal to 0.01 wt. % to less than or equal to 1 wt. % boron, and greater than or equal to 75 wt. % to less than or equal to 88 wt. % aluminum, wherein the alloy has a yield strength of greater than or equal to 200 MPa at 300° C., an ultimate tensile strength of greater than or equal to 250 MPa at 300° C., and a density of greater than or equal to 99.2%.

In some aspects, the techniques described herein relate to an alloy, including greater than or equal to 5 wt. % to less than or equal to 7 wt. % copper.

In some aspects, the techniques described herein relate to an alloy according to any of the above aspects, including 7 wt. % copper.

In some aspects, the techniques described herein relate to an alloy according to any of the above aspects, further including greater than or equal to 0.01 wt. % to less than or equal to 0.5 wt. % nitrogen.

In some aspects, the techniques described herein relate to an alloy according to any of the above aspects, further including greater than or equal to 0.01 wt. % to less than or equal to 0.8 wt. % iron.

In some aspects, the techniques described herein relate to an alloy according to any of the above aspects, further including greater than or equal to 0.01 wt. % to less than or equal to 0.6 wt. % manganese.

In some aspects, the techniques described herein relate to an alloy according to any of the above aspects, further including greater than or equal to 0.01 wt. % to less than or equal to 0.6 wt. % magnesium.

In some aspects, the techniques described herein relate to an alloy according to any of the above aspects, further including greater than or equal to 0.01 wt. % to less than or equal to 0.3 wt. % titanium.

In some aspects, the techniques described herein relate to an alloy according to any of the above aspects, further including greater than or equal to 0.01 wt. % to less than or equal to 0.5 wt. % nitrogen, greater than or equal to 0.01 wt. % to less than or equal to 0.8 wt. % iron, greater than or equal to 0.01 wt. % to less than or equal to 0.6 wt. % manganese, greater than or equal to 0.01 wt. % to less than or equal to 0.6 wt. % magnesium, and greater than or equal to 0.01 wt. % to less than or equal to 0.3 wt. % titanium.

In some aspects, the techniques described herein relate to an alloy according to any of the above aspects, wherein the alloy has a density of greater than or equal to 99.5%.

In some aspects, the techniques described herein relate to an alloy according to any of the above aspects, wherein the alloy has a density of greater than or equal to 99.9%.

In some aspects, the techniques described herein relate to an alloy according to any of the above aspects, wherein the alloy has a yield strength of greater than or equal to 300 MPa at 25° C. and a yield strength of greater than or equal to 200 MPa at 300° C.

In some aspects, the techniques described herein relate to an alloy according to any of the above aspects, wherein the alloy has an ultimate tensile strength of greater than or equal to 400 MPa at 25° C. and an ultimate tensile strength of greater than or equal to 250 MPa at 300° C.

In some aspects, the techniques described herein relate to an alloy according to any of the above aspects, wherein the alloy has an elongation at failure of greater than or equal to 3% to less than or equal to 10% at 25° C. and an elongation at failure of greater than or equal to 25% to less than or equal to 40% at 300° C.

### BRIEF DESCRIPTION OF THE DRAWINGS

Aspects, features, benefits, and advantages of the embodiments described herein will be apparent with regard to the following description, appended claims, and accompanying drawings where:

FIG. 1 shows a micrograph of the precursor powder used in the present method containing 7 wt. % copper and boron nitride nanoparticles (AMALLOY3D.7-HT), according to an embodiment of the present disclosure, identifying copper, boron nitride (BN) nanoparticles, and a powder containing aluminum and silicon (AlSi10 Mg).

FIG. 2A shows the cross-sectional micrographs of an alloy containing 7 wt. % copper without boron nitride nanoparticles (AMALLOY3D.7) compared to a commercially available AlSi10 Mg alloy after the PBF-LB process, and FIG. 2B shows the cross-sectional micrographs of an alloy according to an embodiment of the present disclosure which includes 7 wt. % copper and boron nitride nanoparticles (AMALLOY3D.7-HT) compared to an alloy containing 7 wt. % copper without boron nitride nanoparticles (AMALLOY3D.7).

FIG. 3 shows the electron back scattered diffraction (EBSD) inverse pole figure (IPF) maps of an alloy according to an embodiment of the present disclosure compared to an alloy which does not contain boron nitride nanoparticles.

FIG. 4 shows heat map pole figures showing the texture intensity for an alloy according to an embodiment of the present disclosure compared to an alloy which does not contain boron nitride nanoparticles.

FIG. 5 is a graph of stress-strain tensile curves at room temperature and 300° C. of an alloy according to an embodiment of the present disclosure compared to an alloy which does not contain boron nitride nanoparticles.

FIG. 6 is a graph showing the relationship between yield strength and temperature of an alloy according to an embodiment of the present disclosure compared to an alloy which does not contain boron nitride nanoparticles and several commercially available high strength aluminum alloys.

FIGS. 7A and 7B show bright field scanning transmission electron microscopy (BF-STEM) images and corresponding EDS maps of AMALLOY3D.7 in FIG. 7A and AMALLOY3D.7-HT which contains boron in FIG. 7B, according to an embodiment of the present disclosure.

FIGS. 8A, 8C, and 8E show the fracture surface of AMALLOY3D.7 and FIGS. 8B, 8D, and 8F show the fracture surface of AMALLOY3D.7-HT which contains boron, according to an embodiment of the present disclosure.

### DETAILED DESCRIPTION

According to embodiments of the present disclosure, a method for preparing a three-dimensional article including an alloy is provided. The composition of the alloy and methods of utilizing this alloy in additive manufacturing are also described. The presently disclosed alloy offers a high strength composition that may be used in the production of various functional parts via additive manufacturing techniques. The present alloy may be used in numerous applications, including but not limited to the production of parts for the automotive, aerospace, and manufacturing industries. These applications may require finely designed, high performance parts which are not possible with traditional alloys and traditional manufacturing techniques. The articles printed with the compositions of the present disclosure can be used in several industrial sectors, such as space, aerospace/aviation, and energy. These materials can replace the existing high-strength aluminum alloys for end-use cases requiring light weight combined with high strength at elevated temperatures.

Before describing the embodiments in detail, the following definitions are used throughout the present disclosure.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55% and also includes exactly 50%. Stated differently, where any value is described herein as modified by the term “about”, the exact value is also disclosed.

As used in this disclosure, the concept of “relative density” is discussed. This term refers to the content of solid material vs. void space in an article prepared via additive manufacturing, and may also be known as infill density. That is, an article which is described as having a relative density of 99.9% will have 0.1% void space. Those skilled in the art will understand that a relative density of 100% indicates an additively manufactured article which is completely solid and has no voids within the article. It will be further understood that the concept of “relative density” is referred to as simply “density” in the art, and as such, the terms “relative density” and “density” are used interchangeably in this disclosure. “Density” as used herein refers exclusively to “relative density,” as will be apparent from the corresponding units and general context.

As used herein, “hardness” refers to a measure of the resistance to localized plastic deformation induced by either mechanical indentation or abrasion, as would be familiar to those skilled in the art. Hardness may be determined by any method including but not limited to the Vickers Hardness Test. As used herein, hardness is reported in Vickers Pyramid Number (HV).

As used herein, “yield strength” refers to its common meaning in the field of materials science; that is, the stress corresponding to the yield point at which the material begins to deform plastically. Any method of determining yield strength may be used to evaluate the compositions of the present disclosure.

As used herein, “ultimate tensile strength” refers to the maximum stress or load that a material can withstand while being stretched or pulled before breaking, and may be determined by any method including performing a tensile test and a stress-strain analysis.

As used herein, “elongation at failure” refers to the permanent stretch of a material at its failure point; that is, a measure of the ductility of the material.

As used herein, the term “AMALLOY3D” refers to the alloy grades of the present disclosure. “AMALLOY3D.x” may also be used, wherein “x” refers to the weight percent of copper included in the alloy.

In embodiments, there is provided a method for preparing a three-dimensional article including an alloy, the method including steps of: (a) depositing a first layer of a precursor powder including aluminum, silicon, copper, and boron onto a build platform; (b) contacting the first layer of the precursor powder with an energy source to form a solid layer of the alloy; (c) depositing a subsequent layer of the precursor powder on top of the solid layer; and (d) contacting the subsequent layer of the precursor powder with the energy source to fuse the subsequent layer of the precursor powder to the solid layer, thereby forming the three-dimensional article.

In embodiments, the method can also include a step of preparing the precursor powder prior to the step of (a) depositing a first layer of the precursor powder onto a build platform. In embodiments, the precursor powder can be ready to use.

In embodiments, the precursor powder can include greater than or equal to about 4 wt. % to less than or equal to about 8 wt. % copper, relative to the total weight of the precursor powder. For example, the precursor powder can include about 4 wt. %, about 4.5 wt. %, about 5 wt. %, about 5.5 wt. %, about 6 wt. %, about 6.5 wt. %, about 7 wt. %, about 7.5 wt. %, about 8 wt. % copper, or any value contained within a range formed by any two of the preceding values.

In embodiments, the precursor powder can include greater than or equal to about 4 wt. % to less than or equal to about 8 wt. % copper, and greater than or equal to about 8 wt. % to less than or equal to about 11 wt. % silicon, relative to the total weight of the precursor powder. For example, in embodiments, the precursor powder can include about 8 wt. %, about 8.5 wt. %, about 9 wt. %, about 9.5 wt. %, about 10 wt. %, about 10.5 wt. %, about 11 wt. % silicon, or any value contained within a range formed by any two of the preceding values. The precursor powder can include any combination of copper and silicon content, such that the precursor powder includes about 4 wt. % to about 8 wt. % copper and about 8 wt. % to about 11 wt. % silicon. In embodiments, the precursor powder can include greater than or equal to about 4 wt. % to less than or equal to about 8 wt. % copper, and greater than or equal to about 8 wt. % to less than or equal to about 11 wt. % silicon, and greater than or equal to 75 wt. % to less than or equal to 88 wt. % aluminum, such that the total wt. % equals 100%.

In embodiments, the precursor powder can include greater than or equal to about 0.01 wt. % to less than or equal to about 1 wt. % ceramic nanoparticles. For example, the precursor powder can include about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, or about 1 wt. % ceramic nanoparticles, or any value contained within a range formed by any two of the preceding values. In embodiments, the ceramic nanoparticles can include boron nitride nanoparticles. In embodiments, the ceramic nanoparticles can include boron nitride nanoparticles in the form of flakes. The boron nitride nanoparticles may, in embodiments, have a hexagonal crystal structure. It is contemplated that the inoculation of boron nitride nanoparticles in an alloy composition may, without wishing to be bound by theory, improve the high-temperature tensile performances of the alloy due to a combined effect of grain refinement and dispersion strengthening at the nanoscale.

In embodiments, the precursor powder can include greater than or equal to about 0.01 wt. % to less than or equal to about 1 wt. % boron. For example, the precursor powder can include about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, or about 1 wt. % boron, or any value contained within a range formed by any two of the preceding values. In embodiments, the boron can be introduced in the form of a pre-alloyed element or in the form of boron nitride nanoparticles. In embodiments, the boron nitride nanoparticles may be in the form of flakes. The boron nitride nanoparticles may, in embodiments, have a hexagonal crystal structure. It is contemplated that the introduction of boron in an alloy composition may, without wishing to be bound by theory, improve the high-temperature tensile performances of the alloy due to a combined effect of grain refinement and dispersion strengthening.

In embodiments, the precursor powder can include a balance of aluminum, such as about 75 wt. %, about 76 wt. %, about 77 wt. %, about 78 wt. %, about 79 wt. %, about 80 wt. %, about 81 wt. %, about 82 wt. %, about 83 wt. %, about 84 wt. %, about 85 wt. %, about 86 wt. %, about 87 wt. %, about 88 wt. % aluminum, or any value contained within a range formed by any two of the preceding values. The precursor powder may include any amounts of copper, silicon, boron, iron, manganese, magnesium, titanium, aluminum, or combinations thereof as disclosed herein, such that the wt. % of the components in the precursor powder equals 100 wt. %.

In embodiments, the precursor powder can further include greater than or equal to about 0.01 wt. % to less than or equal to about 0.5 wt. % nitrogen, such as about 0.01 wt. %, about 0.05 wt. %, about 0.1 wt. %, about 0.2 wt. %, about 0.3 wt. %, about 0.4 wt. %, about 0.5 wt. %, or any value contained within a range formed by any two of the preceding values. In embodiments, the precursor powder does not include nitrogen.

In embodiments, the precursor powder can further include greater than or equal to about 0.01 wt. % to less than or equal to about 0.8 wt. % iron, such as about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. % iron, or any value contained within a range formed by any two of the preceding values. In embodiments, the precursor powder does not include iron.

In embodiments, the precursor powder can further include greater than or equal to about 0.01 wt. % to less than or equal to about 0.6 wt. % manganese, such as about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, about 0.1 wt. %, about 0.2 wt. %, about 0.3 wt. %, about 0.4 wt. %, about 0.5 wt. %, about 0.6 wt. % manganese, or any value contained within a range formed by any two of the preceding values. In embodiments, the precursor powder does not include manganese.

In embodiments, the precursor powder can further include greater than or equal to about 0.01 wt. % to less than or equal to about 0.6 wt. % magnesium, such as such as about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, about 0.1 wt. %, about 0.2 wt. %, about 0.3 wt. %, about 0.4 wt. %, about 0.5 wt. %, about 0.6 wt. % magnesium, or any value contained within a range formed by any two of the preceding values. In embodiments, the precursor powder does not include magnesium.

In embodiments, the precursor powder can further include greater than or equal to about 0.01 wt. % to less than or equal to about 0.3 wt. % titanium, such as such as about 0.01 wt. %, about 0.02 wt. %, about 0.03 wt. %, about 0.04 wt. %, about 0.05 wt. %, about 0.1 wt. %, about 0.15 wt. %, about 0.2 wt. %, about 0.25 wt. %, about 0.3 wt. % titanium, or any value contained within a range formed by any two of the preceding values. In embodiments, the precursor powder does not include titanium.

In embodiments, the precursor powder can further include greater than or equal to about 0.01 wt. % to less than or equal to about 0.8 wt. % iron, greater than or equal to about 0.01 wt. % to less than or equal to about 0.6 wt. % magnesium, greater than or equal to less than or equal to about 0.01 wt. % to about 0.6 wt. % manganese, greater than or equal to about 0.01 wt. % to less than or equal to about 0.3 wt. % titanium, or any combination thereof. For example, the precursor powder may include one or more of iron, manganese, magnesium, and titanium in the amounts disclosed herein.

In embodiments, the precursor powder can include greater than or equal to about 4 wt. % to less than or equal to about 8 wt. % copper, greater than or equal to about 8 wt. % to less than or equal to about 11 wt. % silicon, greater than or equal to about 0.01 wt. % to less than or equal to about 1 wt. % boron, greater than about 0.01 wt. % to less than or equal to about 0.8 wt. % iron, greater than or equal to about 0.01 wt. % to less than or equal to about 0.6 wt. % magnesium, greater than or equal to less than or equal to about 0.01 wt. % to about 0.6 wt. % manganese, greater than or equal to about 0.01 wt. % to less than or equal to about 0.3 wt. % titanium, greater than or equal to about 0.01 wt. % to less than or equal to about 0.5 wt. % nitrogen, and greater than or equal to 75 wt. % to less than or equal to 88 wt. % aluminum, such that the total wt. % equals 100%.

In embodiments, the method can further include preparing the precursor powder. In embodiments, preparing the precursor powder can include combining a copper-containing powder with a silicon-containing powder and boron. For example, in embodiments, elemental copper powder may be combined with a silicon-containing powder, which may or may not include other components as described herein. For example, in embodiments, the silicon-containing powder is an aluminum-silicon-containing powder. In embodiments, the silicon-containing powder is an aluminum-silicon-magnesium-containing powder. In embodiments, preparing the precursor powder can include combining boron, an elemental copper powder, and a pre-alloyed powder which includes silicon and aluminum. In embodiments, preparing the precursor powder can include combining elemental powders of each of copper, silicon, and aluminum with boron. In embodiments, the boron may be in the form of boron nitride nanoparticles.

In embodiments, the method can further include preparing the precursor powder, wherein preparing the precursor powder can include mixing the precursor powder via ball milling, sizing the precursor powder via vibratory sieving, or a combination thereof. In embodiments, preparing the precursor powder can include sizing the precursor powder via a sizing method including but not limited to vibratory sieving. In embodiments, sizing the precursor powder uses a sizing method which preserves the sphericity of the precursor powder particles. In embodiments, the precursor powder has an average particle size of greater than or equal to about 1 μm to less than or equal to about 65 μm, such as about 1 μm, about 2 μm, about 3 μm, about 4 μm, about 5 μm, about 10 μm, about 15 μm, about 20 μm, about 25 μm, about 30 μm, about 35 μm, about 40 μm, about 45 μm, about 50 μm, about 55 μm, about 60 μm, about 65 μm, or any value contained within a range formed by any two of the preceding values. In embodiments, the precursor powder includes a first population of powder particles having a first average particle size and a second population of particles having a second average particle size. In embodiments, the precursor powder further includes a third population of particles having a third average particle size. It is contemplated that any of the first average particle size, the second average particle size, or the third average particle size may have the same or different values within the range of about 10 μm to about 65 μm.

In embodiments, preparing the precursor powder can include sizing the precursor powder to a particle size distribution of about 1 μm to about 65 μm. In embodiments, the precursor powder has a D10 value between about 2 μm and about 30 μm, such as about 2 μm, about 5 μm, about 10 μm, about 15 μm, about 20 μm, about 25 μm, about 30 μm, or any value contained within a range formed by any two of the preceding values. In embodiments, the precursor powder has a D50 value between about 35 μm and about 45 μm, such as about 35 μm, about 40 μm, about 45 μm, or any value contained within a range formed by any two of the preceding values. In embodiments, the precursor powder has a D90 value between about 55 μm and 65 μm, such as about 55 μm, about 56 μm, about 57 μm, about 58 μm, about 59 μm, about 60 μm, about 61 μm, about 62 μm, about 63 μm, about 64 μm, about 65 μm, or any value contained within a range formed by any two of the preceding values. In embodiments, the precursor powder has a D10 value of about 25 μm, a D50 value of about 40 μm, and a D90 value of about 65 μm. In embodiments, the precursor powder has a D10 value of about 27 μm, a D50 value of about 42 μm, and a D90 value of about 65 μm. Those skilled in the art will understand D10 and D90 to be points on a particle size distribution curve, according to the common meaning of these terms in the field. The presently disclosed values for particle size distribution were determined by laser diffraction, though those skilled in the art that other methods of determining particle size are available and may be employed as needed.

In embodiments, preparing the precursor powder can include combining an elemental copper power with a pre-alloyed powder containing silicon and aluminum, and sizing this mixture as described herein. In embodiments, the boron may be added to the mixture of the copper-containing powder and the silicon-containing powder before or after sizing, as described herein.

In embodiments, the precursor powder containing the boron, the copper-containing powder, and the silicon-containing powder are mixed after sizing. In embodiments, the precursor powder may be sized a second time after mixing. It is contemplated that the boron may adhere to the other powder components, such that the average particle size falls within the range disclosed herein. It is further contemplated that the boron may, in embodiments, agglomerate, such that the precursor powder contains agglomerates which may have an individual particle size of less than or equal to 1 μm. The average particle size and particle size distribution disclosed herein do not exclude the presence of such agglomerates, nor that of boron or ceramic nanoparticles which do not adhere to or surround the copper-containing powder particles or the silicon-containing powder particles. That is, without wishing to be bound by theory, the precursor powder may include copper-containing powder particles and silicon-containing powder particles which have an average particle size and particle size distribution as described herein and may also include boron and boron agglomerates which are of a smaller size.

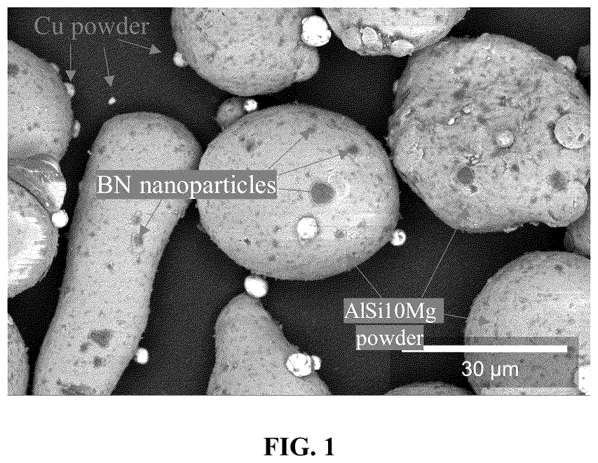

In embodiments, preparing the precursor powder can include mixing the precursor powder via ball milling. FIG. 1 shows a micrograph of the precursor powder used in the present method containing 7 wt. % copper and boron nitride nanoparticles (AMALLOY3D.7-HT), according to an embodiment of the present disclosure, identifying copper, boron nitride (BN) nanoparticles, and a powder containing aluminum and silicon (AlSi10 Mg).

In embodiments, there is provided a method for preparing a three-dimensional article including an alloy, the method including steps of: (a) depositing a first layer of a precursor powder including aluminum, silicon, copper, and boron onto a build platform; (b) contacting the first layer of the precursor powder with an energy source to form a solid layer of the alloy; (c) depositing a subsequent layer of the precursor powder on top of the solid layer; and (d) contacting the subsequent layer of the precursor powder with the energy source to fuse the subsequent layer of the precursor powder to the solid layer, thereby forming the three-dimensional article.

In embodiments, the step of (a) depositing a first layer of the precursor powder onto a build platform can include depositing the precursor powder onto a build platform, wherein the build platform is at a temperature of greater than or equal to about 100° C. to less than or equal to about 300° C. For example, in embodiments, the build platform is at a temperature of about 100° C., about 110° C., about 120° C., about 130° C., about 140° C., about 150° C., about 160° C., about 170° C., about 180° C., about 190° C., 200° C., about 210° C., about 220° C., about 230° C., about 240° C., about 250° C., about 260° C., about 270° C., about 280° C., about 290° C., about 300° C., or any value contained within a range formed by any two of the preceding values. The dimensions of the build platform are not limited. Any method of depositing the first layer of the precursor powder onto the build platform is acceptable within the present method.

As will be familiar to those skilled in the art of additive manufacturing, the dimensions of each layer need not be the same (but may be the same, in embodiments), and are not particularly limited. The dimensions of each layer may be selected and set by a skilled artisan depending on the shape and parameters of the article to be produced. The following values for layer thickness are merely exemplary and are not limiting. It is contemplated that other values for layer thickness may be used and are within the scope of the present disclosure.

In embodiments, the first layer of the precursor powder can have a thickness of about 10 μm to about 200 μm. For example, in embodiments, the first layer of the precursor powder has a thickness of about 10 μm, about 20 μm, about 30 μm, about 40 μm, about 50 μm, about 60 μm, about 70 μm, about 80 μm, about 90 μm about 100 μm, about 110 μm, about 120 μm, about 130 μm, about 140 μm, about 150 μm, about 160 μm, about 170 μm, about 180 μm, about 190 μm, about 200 μm, or any value contained within a range formed by any two of the preceding values. The length and width dimensions of the first layer of the precursor powder are not limited.

In embodiments, the step of (b) contacting the first layer of the precursor powder with an energy source to form a solid layer includes the use of a laser having process parameters which may be adjusted as determined by one of ordinary skill in the art.

The process parameters used for the method described herein are not particularly limited and may be selected by a person of ordinary skill in the art based on the article to be produced and the machine used for additive manufacturing. The following process parameters are merely exemplary and are not intended to be limiting. In embodiments, the energy source can include a laser having a power of about 300 W to about 500 W and a scan speed of about 1200 mm/s to about 2200 mm/s. For example, in embodiments, the energy source may include a laser having a power of about 300 W, about 320 W, about 340 W, about 360 W, about 380 W, about 400 W, about 420 W, about 440 W, about 460 W, about 480 W, about 500 W, or any value contained within a range formed by any two of the preceding values. In embodiments, the energy source can include a laser having a scan speed of about 1200 mm/s, about 1400 mm/s, about 1600 mm/s, about 1800 mm/s, about 2000 mm/s, about 2200 mm/s, or any value contained within a range formed by any two of the preceding values. Other values and other process parameters may also be appropriate in embodiments, depending on the machine used and the article to be produced.

In embodiments, the method includes a step of (c) depositing a subsequent layer of the precursor powder on top of the solid layer. In embodiments, the subsequent layer of the precursor powder can have a thickness of about 10 μm to about 200 μm. For example, in embodiments, the subsequent layer of the precursor powder has a thickness of about 10 μm, about 20 μm, about 30 μm, about 40 μm, about 50 μm, about 60 μm, about 70 μm, about 80 μm, about 90 μm about 100 μm, about 110 μm, about 120 μm, about 130 μm, about 140 μm, about 150 μm, about 160 μm, about 170 μm, about 180 μm, about 190 μm, about 200 μm, or any value contained within a range formed by any two of the preceding values. In embodiments where multiple subsequent layers of the precursor powder are present, each individual subsequent layer may have a thickness of about 10 μm to about 200 μm as described herein. Each individual subsequent layer may have the same or different thickness, within the range of about 10 μm to about 200 μm. The length and width dimensions of the subsequent layer of the precursor powder are not limited.

In embodiments, the method can include a step of (d) contacting the subsequent layer of the precursor powder with the energy source to fuse the subsequent layer of the precursor powder to the solid layer. As described previously, the settings and parameters of the energy source are not particularly limited and may be adjusted by one skilled in the art. The parameters of the energy source used to fuse the subsequent layer(s) to the solid layer may be same or different from the parameters used to consolidate the first layer of the precursor powder into the solid layer.

In embodiments, the method can include a step of (c) repeating steps (c) through (d) a plurality of times, that is, depositing a subsequent layer of the precursor powder on top of the solid layer and contacting the subsequent layer of the precursor powder with the energy source to fuse the subsequent layer of the precursor powder to the solid layer. Steps (c) through (d) may be repeated any number of times, such as 10 times, 50 times, 100 times, 500 times, and so forth. The number of times that steps (c) through (d) are repeated is not particularly limited and may be influenced by the dimensions and complexity of the three-dimensional article to be produced.

The three-dimensional article including the alloy that is produced by the method disclosed herein is not in any way limited and may be any size or shape and have any dimensions and features. In embodiments, the three-dimensional article formed from an alloy which is produced by the present method has a density of greater than or equal to about 99.2%, such as about 99.5%, about 99.9%, or any value contained within a range formed by any two of the preceding values. In embodiments, the alloy has a yield strength (YS) of greater than or equal to about 200 MPa at 300° C., an ultimate tensile strength (UTS) of greater than or equal to about 250 MPa at 300° C., a density of greater than or equal to about 99.2%, or any combination of these properties.

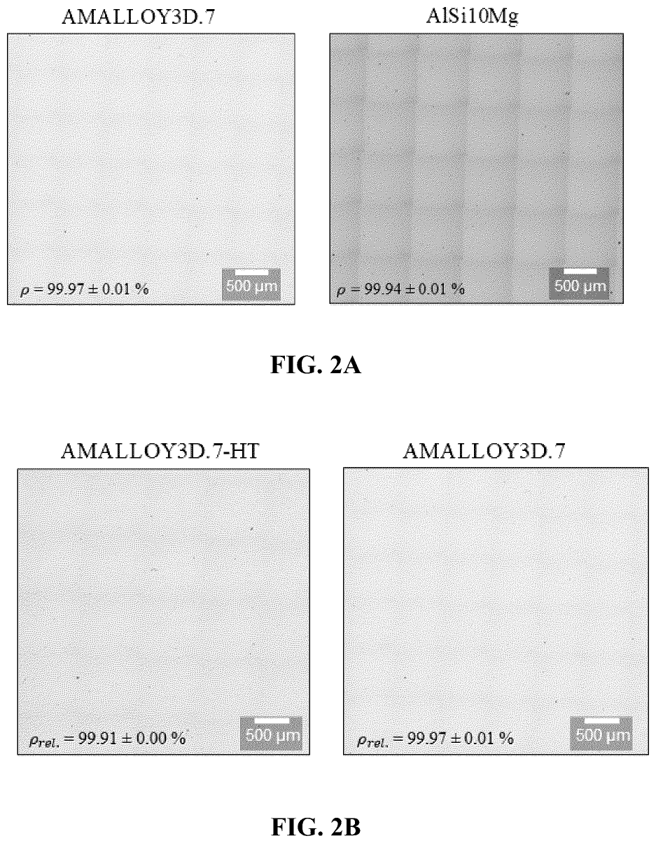

In embodiments, the alloy prepared by methods disclosed herein can have a density of greater than or equal to 99.5%, or greater than or equal to 99.9%. FIG. 2A shows the cross-sectional micrographs of an alloy containing 7 wt. % copper without boron nitride nanoparticles (AMALLOY3D.7) compared to a commercially available AlSi10 Mg alloy after the PBF-LB process, and FIG. 2B shows the cross-sectional micrographs of an alloy according to an embodiment of the present disclosure which includes 7 wt. % copper and boron nitride nanoparticles (AMALLOY3D.7-HT) compared to an alloy containing 7 wt. % copper without boron nitride nanoparticles (AMALLOY3D.7). FIG. 2B shows that the alloy of according to an embodiment of the present disclosure achieves a density of greater than or equal to 99.9%.

In embodiments, there is provided a method for producing an alloy structure having a density of greater than or equal to about 99.2%, including providing a precursor powder which includes greater than or equal to about 4 wt. % to less than or equal to about 8 wt. % copper and greater than or equal to about 0.01 wt. % to less than or equal to about 1 wt. % ceramic nanoparticles to an additive manufacturing system; and contacting the precursor powder with an energy source to form the alloy structure.

In embodiments, there is provided a method for producing an alloy structure having a density of greater than or equal to about 99.2%, including providing a precursor powder which includes greater than or equal to about 4 wt. % to less than or equal to about 8 wt. % copper and greater than or equal to about 0.01 wt. % to less than or equal to about 1 wt. % boron to an additive manufacturing system; and contacting the precursor powder with an energy source to form the alloy structure.

In embodiments, the precursor powder can include about 4 wt. % to about 8 wt. % copper, about 8 wt. % to about 11 wt. % silicon, greater than or equal to about 0.01 wt. % to less than or equal to about 1 wt. % boron, and about 75 wt. % to about 88 wt. % aluminum. In embodiments, the precursor powder can further include about 0.01 wt. % to about 0.5 wt. % nitrogen, about 0.01 wt. % to about 0.8 wt. % iron, about 0.01 wt. % to about 0.6 wt. % manganese, about 0.01 wt. % to about 0.6 wt. % magnesium, about 0.01 wt. % to about 0.3 wt. % titanium, or any combination thereof. As described herein, the precursor powder may include any amounts of copper, silicon, iron, manganese, magnesium, titanium, aluminum, or combinations thereof as disclosed herein, such that the total wt. % of the components in the precursor powder equals 100 wt. %.

In embodiments, the boron can be in the form of boron nitride nanoparticles, such as hexagonal boron nitride nanoparticles in the form of flakes.

In embodiments, the precursor powder can include a mixture of a copper-containing powder, boron, and a silicon-containing powder, such as an elemental copper powder, boron nitride nanoparticles, and a pre-alloyed silicon-containing powder, as described herein.

In embodiments, the additive manufacturing system can include directed energy deposition, powder bed fusion, or combinations thereof. In embodiments, the additive manufacturing system includes powder bed fusion with a laser beam or an electron beam.

In embodiments, the energy source can include a laser having a power of about 300 W to about 500 W and a scan speed of about 1200 mm/s to about 2200 mm/s, as described herein. The process parameters of the energy source are not particularly limited and may be adjusted as required.

In embodiments, the method further includes sizing the precursor powder via vibratory sieving prior to contacting the precursor powder with an energy source. Sizing the precursor powder may be performed by any method as disclosed herein using the conventional parameters and instruments familiar to those skilled in the art. In embodiments, the precursor powder can be sized to an average particle size of about 1 μm to about 65 μm. In embodiments, the precursor powder can be mixed after it is sized.

In embodiments, providing the precursor powder can include depositing the precursor powder onto a build plate at a temperature of greater than or equal to about 100° C. to less than or equal to about 300° C. For example, in embodiments, the build plate is at a temperature of about 100° C., about 110° C., about 120° C., about 130° C., about 140° C., about 150° C., about 160° C., about 170° C., about 180° C., about 190° C., 200° C., about 210° C., about 220° C., about 230° C., about 240° C., about 250° C., about 260° C., about 270° C., about 280° C., about 290° C., about 300° C., or any value contained within a range formed by any two of the preceding values.

In embodiments, contacting the precursor powder with the energy source results in solidifying the precursor powder to consolidate the alloy structure, such that the alloy structure has a density of greater than or equal to about 99.2%. In embodiments, contacting the precursor powder with the energy source results in solidifying the precursor powder to consolidate the alloy structure, such that the alloy structure has a density of greater than or equal to about 99.5%, such as about 99.5%, about 99.6%, about 99.7%, about 99.8%, about 99.9%, about 100.0%, or any value contained within a range formed by any two of the preceding values. In embodiments, contacting the precursor powder with the energy source results in solidifying the precursor powder to consolidate the alloy structure, such that the alloy structure has a yield strength of greater than or equal to 200 MPa at 300° C., an ultimate tensile strength of greater than or equal to 250 MPa at 300° C., and a density of greater than or equal to 99.2%.

In embodiments, there is provided an alloy which can include greater than or equal to about 4 wt. % to less than or equal to about 8 wt. % copper, greater than or equal to about 8 wt. % to less than or equal to about 11 wt. % silicon, greater than or equal to about 0.01 wt. % to less than or equal to about 1 wt. % boron, and greater than or equal to about 75 wt. % to less than or equal to about 88 wt. % aluminum, wherein the alloy has a yield strength of greater than or equal to 200 MPa at 300° C., an ultimate tensile strength of greater than or equal to 250 MPa at 300° C., and a density of greater than or equal to 99.2%. The alloy may be formed by any of the methods or embodiments described herein.

In embodiments, the alloy can further include greater than or equal to about 0.01 wt. % to less than or equal to about 0.5 wt. % nitrogen. In embodiments, the alloy can further include greater than or equal to about 0.01 wt. % to less than or equal to about 0.8 wt. % iron. In embodiments, the alloy can further include greater than or equal to less than or equal to about 0.01 wt. % to about 0.6 wt. % manganese. In embodiments, the alloy can further include greater than or equal to about 0.01 wt. % to less than or equal to about 0.3 wt. % titanium. In embodiments, the alloy can further include greater than or equal to about 0.01 wt. % to less than or equal to about 0.6 wt. % magnesium. In embodiments, the alloy can further include greater than or equal to about 0.01 wt. % to less than or equal to about 0.5 wt. % nitrogen, greater than or equal to about 0.01 wt. % to less than or equal to about 0.8 wt. % iron, greater than or equal to about 0.01 wt. % to less than or equal to about 0.6 wt. % magnesium, greater than or equal to less than or equal to about 0.01 wt. % to about 0.6 wt. % manganese, greater than or equal to about 0.01 wt. % to less than or equal to about 0.3 wt. % titanium, or any combination thereof.

In embodiments, the alloy includes about 4 wt. %, about 4.5 wt. %, about 5 wt. %, about 5.5 wt. %, about 6 wt. %, about 6.5 wt. %, about 7 wt. %, about 7.5 wt. %, about 8 wt. % copper, or any value contained within a range formed by any two of the preceding values.

In embodiments, the alloy includes about 8 wt. %, about 8.5 wt. %, about 9 wt. %, about 9.5 wt. %, about 10 wt. %, about 10.5 wt. %, about 11 wt. % silicon, or any value contained within a range formed by any two of the preceding values.

In embodiments, the alloy includes about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, or about 1 wt. % boron, or any value contained within a range formed by any two of the preceding values. In embodiments, the boron is in the form of boron nitride nanoparticles.

In embodiments, the alloy can include greater than or equal to about 0.01 wt. % to less than or equal to about 0.5 wt. % nitrogen, such as about 0.01 wt. %, about 0.05 wt. %, about 0.1 wt. %, about 0.2 wt. %, about 0.3 wt. %, about 0.4 wt. %, about 0.5 wt. %, or any value contained within a range formed by any two of the preceding values. In embodiments, the alloy does not include nitrogen.

In embodiments, the alloy can include about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. % iron, or any value contained within a range formed by any two of the preceding values. In embodiments, the alloy does not include iron.

In embodiments, the alloy can include about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, about 0.1 wt. %, about 0.2 wt. %, about 0.3 wt. %, about 0.4 wt. %, about 0.5 wt. %, about 0.6 wt. % manganese, or any value contained within a range formed by any two of the preceding values. In embodiments, the alloy does not include manganese.

In embodiments, the alloy can include about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, about 0.1 wt. %, about 0.2 wt. %, about 0.3 wt. %, about 0.4 wt. %, about 0.5 wt. %, about 0.6 wt. % magnesium, or any value contained within a range formed by any two of the preceding values. In embodiments, the alloy does not include magnesium.

In embodiments, the alloy can include about 0.01 wt. %, about 0.02 wt. %, about 0.03 wt. %, about 0.04 wt. %, about 0.05 wt. %, about 0.1 wt. %, about 0.15 wt. %, about 0.2 wt. %, about 0.25 wt. %, about 0.3 wt. % titanium, or any value contained within a range formed by any two of the preceding values. In embodiments, the alloy does not include titanium.

In embodiments, the alloy includes about 75 wt. %, about 76 wt. %, about 77 wt. %, about 78 wt. %, about 79 wt. %, about 80 wt. %, about 81 wt. %, about 82 wt. %, about 83 wt. %, about 84 wt. %, about 85 wt. %, about 86 wt. %, about 87 wt. %, about 88 wt. % aluminum, or any value contained within a range formed by any two of the preceding values. The alloy may include any amounts of copper, silicon, iron, manganese, magnesium, titanium, and aluminum as disclosed herein, such that the total wt. % of the components in the alloy equals 100 wt. %.

In embodiments, the alloy can have a hardness of greater than or equal to about 140 HV to about 200 HV, such as about 140 HV, about 150 HV, about 160 HV, about 170 HV, about 180 HV, about 190 HV, about 200 HV, or any value contained within a range formed by any two of the preceding values. In embodiments, the inclusion of boron in the alloy does not reduce the hardness relative to an alloy which does not contain boron, without wishing to be bound by theory.

In embodiments, the alloy can have a density of greater than or equal to about 99.2%. For example, in embodiments, the alloy can have a density of about 99.2%, about 99.3%, about 99.4%, about 99.5%, about 99.6%, about 99.7%, about 99.8%, about 99.9%, about 99.95%, about 99.96%, about 99.97%, about 99.98%, about 99.99%, up to 100%, or any value contained within a range formed by any two of the preceding values. The cross-sectional micrographs in FIG. 2A and FIG. 2B are of cuboids having dimensions of 10 mm×10 mm×10 mm that were cut off along the building direction from larger parts of the as—printed material. According to the relative densities achieved after the PBF-LB process, the alloy of the present disclosure reached a higher density than the commercial AlSi10 Mg alloy. This is shown in FIG. 2A and FIG. 2B, as there are fewer macroscopic pores or ridges in micrograph for the alloy of the present disclosure as compared to that of AlSi10 Mg.

In embodiments, the alloy may exhibit excellent mechanical properties at high temperature, such as up to 300° C. It is contemplated that the inclusion of boron in the alloy may enhance the high-temperature stability of the alloy, without wishing to be bound by theory. In embodiments, the alloy may have a yield strength (YS) of greater than or equal to about 300 MPa at 25° C., a yield strength of greater than or equal to about 300 MPa at 160° C., a yield strength of greater than or equal to about 300 MPa at 220° C., and a yield strength of greater than or equal to about 200 MPa at 300° C.

In embodiments, the alloy may have an ultimate tensile strength (UTS) of greater than or equal to about 400 MPa at 25° C., an ultimate tensile strength of greater than or equal to about 400 MPa at 160° C., an ultimate tensile strength of greater than or equal to about 350 MPa at 220° C., and an ultimate tensile strength of greater than or equal to about 250 MPa at 300° C.

In embodiments, the alloy may have an elongation at failure of greater than or equal to about 3% to less than or equal to about 10%, such as about 3%, about 4%, about 5%, about 6%, about 7%, about 8%, about 9%, about 10%, or any value contained within a range formed by any two of the preceding values, at a temperature of 25° C. In embodiments, the alloy can have an elongation at failure of greater than or equal to about 25% to less than or equal to about 40%, such as about 25%, about 30%, about 35%, about 40%, or any value contained within a range formed by any two of the preceding values, at a temperature of 300° C.

The embodiments disclosed herein may be combined in any manner to form new embodiments. For example, the methods or combinations of methods disclosed herein may be used to produce the alloys disclosed herein.

### EXAMPLES

### Example 1

High-strength aluminum alloys containing copper as described herein were prepared according to an embodiment of the present disclosure. The particle size distribution of the precursor powder prior to adding boron nitride nanoparticles, which included elemental copper powder and pre-alloyed AlSi10 Mg powder, was D10=26.8 μm, D50=41.8 μm, and D90=64.7 μm, as determined by laser diffraction. Boron nitride nanoparticles were then added, and the precursor powder was mixed via simple mixing in a TURBULA mixer.

TABLE 1A

| | Si | Cu | Fe | Mn | Mg | Ti | | BN |
|---|---|---|---|---|---|---|---|---|
| No. | (wt. %) | (wt. %) | (wt. %) | (wt. %) | (wt. %) | (wt. %) | Al | (wt. %) |
| 1 | 9.6 | 4 | 0.53 | 0.43 | 0.43 | 0.14 | Bal. | 0.3 |
| 2 | 9.5 | 5 | 0.52 | 0.43 | 0.43 | 0.14 | Bal. | 0.3 |
| 3 | 9.4 | 6 | 0.52 | 0.42 | 0.42 | 0.14 | Bal. | 0.3 |
| 4 | 9.3 | 7 | 0.51 | 0.42 | 0.42 | 0.14 | Bal. | 0.3 |
| 5 | 9.2 | 8 | 0.51 | 0.41 | 0.41 | 0.14 | Bal. | 0.3 |

TABLE 1A shows the composition of five alloy samples (also referred to herein as “coupons”), according to embodiments of the present disclosure. Aluminum content of “Bal.” means that the remainder of the alloy composition is aluminum, such that the total wt. % of the alloy composition equals 100 wt. %. “BN” refers to boron nitride nanoparticles.

TABLE 1B

| | Si | Cu | Fe | Mn | Mg | Ti | B | N | |
|---|---|---|---|---|---|---|---|---|---|
| No. | (wt. %) | (wt. %) | (wt. %) | (wt. %) | (wt. %) | (wt. %) | (wt. %) | (wt. %) | Al |
| 1 | 9.6 | 4 | 0.53 | 0.43 | 0.43 | 0.14 | 0.13 | 0.17 | Bal. |
| 2 | 9.5 | 5 | 0.52 | 0.43 | 0.43 | 0.14 | 0.13 | 0.17 | Bal. |
| 3 | 9.4 | 6 | 0.52 | 0.42 | 0.42 | 0.14 | 0.13 | 0.17 | Bal. |
| 4 | 9.3 | 7 | 0.51 | 0.42 | 0.42 | 0.14 | 0.13 | 0.17 | Bal. |
| 5 | 9.2 | 8 | 0.51 | 0.41 | 0.41 | 0.14 | 0.13 | 0.17 | Bal. |

TABLE 1B shows the theoretical chemical composition of the five alloy samples of TABLE 1A, accounting for the individual elemental amounts of boron and nitrogen.

The alloy compositions of the present example were formed in-situ by leveraging the PBF-LB process for the actual chemical alloying of AlSi10 Mg and Cu powders with boron nitride nanoparticles (‘in-situ alloying’ process). Studies were conducted to print near-fully dense parts reaching a density level of 99.91+0.01%, evidencing the good printability of the new alloy. The process parameters used to form the alloys using an AconityMIDI+PBF-LB printer is summarized in TABLE 2.

TABLE 2
Parameter sets

| General | | | Hatch | | | Contour | | |
|---|---|---|---|---|---|---|---|---|
| Spot size | 90 | μm | Power | 380 | W | Power | 400 | W |
| Layer thickness | 50 | μm | Hatch | 150 | μm | Contour | 120 | μm |

| | | | distance | | | distance | |
|---|---|---|---|---|---|---|---|
| Scan strategy | Stripe | | Scan | 1350 | | Scan | 2000 |
| | hatching | | speed | mm/s | | Speed | mm/s |
| Build plate | 220° | C. | Stripe | 5 | mm | Contour | 2 |

| | | |
|---|---|---|
| temperature | width | Count |

As shown in FIG. 2A and FIG. 2B, the relative density of the alloy of the present disclosure was comparable to and even exceeded that of the commercially available AlSi10 Mg alloy, meaning that the addition of Cu and boron nitride nanoparticles did not negatively affect the alloy's printability. Therefore, using the parameters of TABLE 2, typical processability defects, such as lack of fusion areas, keyhole pores, stress-induced delamination, and hot cracking were not observed in the alloys according to embodiments of the present disclosure. It is contemplated that other parameters may also be suitable for achieving the results described herein. Other parameters may be necessary when using other printing systems and the above parameters should not be considered limiting.

The chemical composition of the alloys of the present disclosure was evaluated and compared to an alloy which was not prepared using boron nitride nanoparticles. These results are shown in TABLE 3.

TABLE 3

| Alloy Grade | Si | Cu | Fe | Mn | Mg | Ti | B | N | Al |
|---|---|---|---|---|---|---|---|---|---|
| AMALLOY3D.7- | 8.51 | 7.03 | 0.12 | <0.02 | 0.28 | <0.02 | 0.12 | 0.14 | Bal. |
| HT | | | | | | | | | |
| AMALLOY3D.7 | 8.56 | 7.41 | 0.12 | <0.02 | 0.28 | <0.02 | <0.02 | 0.01 | Bal. |

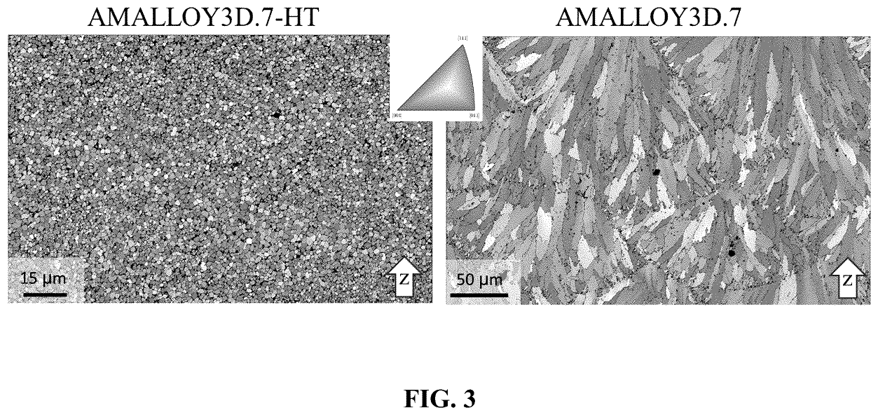

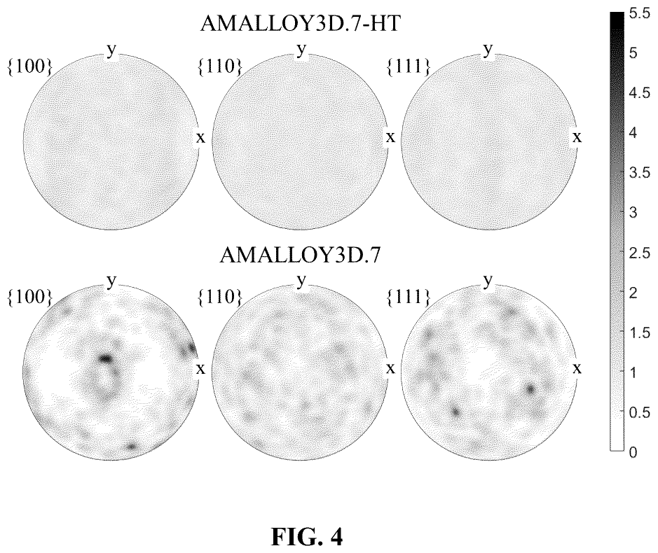

The grain structure of the alloy of the present disclosure containing boron nitride (BN) nanoparticles and copper (AMALLOY3D.7-HT) and its parent alloy (AMALLOY3D.7), containing copper without boron nitride nanoparticles, was investigated by Electron Back Scattered Diffraction (EBSD). FIG. 3 shows the electron back scattered diffraction (EBSD) inverse pole figure (IPF) maps of an alloy according to an embodiment of the present disclosure compared to an alloy which does not contain boron nitride nanoparticles. The inverse pole figures (IPF) orientation maps in FIG. 3 show the grains orientation and their size characteristics. The average grain size was calculated according to the equivalent circle diameter (ECD) assumption. FIG. 4 shows heat map pole figures showing the texture intensity for an alloy according to an embodiment of the present disclosure compared to an alloy which does not contain boron nitride nanoparticles.

In AMALLOY3D.7-HT, the Al-fcc grains are randomly oriented with an equiaxed shape and size of 1.2±1.5 μm (shown in FIG. 3 and TABLE 4), which returned a very low texture along the <100> [001] direction (FIG. 4), which is equivalent at the building direction Z of the PBF-LB process.

TABLE 4

| | | | | | | Grain Size |
|---|---|---|---|---|---|---|
| | Grain | Grain Size | | | | Number [—] |
| | Count | Average | Min | Max | St. Dev | (ASTM |
| Alloy grade | [—] | [μm] | [μm] | [μm] | [μm] | E2627) |
| AMALLOY3D.7- | 13442 | 1.6 | 0.03 | 4.4 | 0.4 | 16.5 |
| HT | | | | | | |
| AMALLOY3D.7 | 2306 | 18 | 1.1 | 50 | 5 | 11.3 |

In the parent grade, the AMALLOY3D.7, the Al-fcc grains with size of 18±1.1 μm (TABLE 4) are more elongated and exhibit occasionally epitaxial growth along the <100> [001] direction resulting in a pronounced {100} texture intensity (as shown in both FIG. 3 and FIG. 4).

Therefore, the introduction of BN nanoflakes in AMALLOY3D.7-HT induced an excellent grain refinement with a grain size reduction of 91% compared to the AMALLOY3D.7 counterpart (TABLE 4). The refinement effect of BN is beneficial to increasing the yield strength of the developed AMALLOY3D.7 for high temperature (HT) applications. In addition, the extreme refinement of the grain structure in AMALLOY3D.7-HT annihilates the typical texture of the PBF-LB process, such as the one in AMALLOY3D.7, resulting in a completely isotropic material.

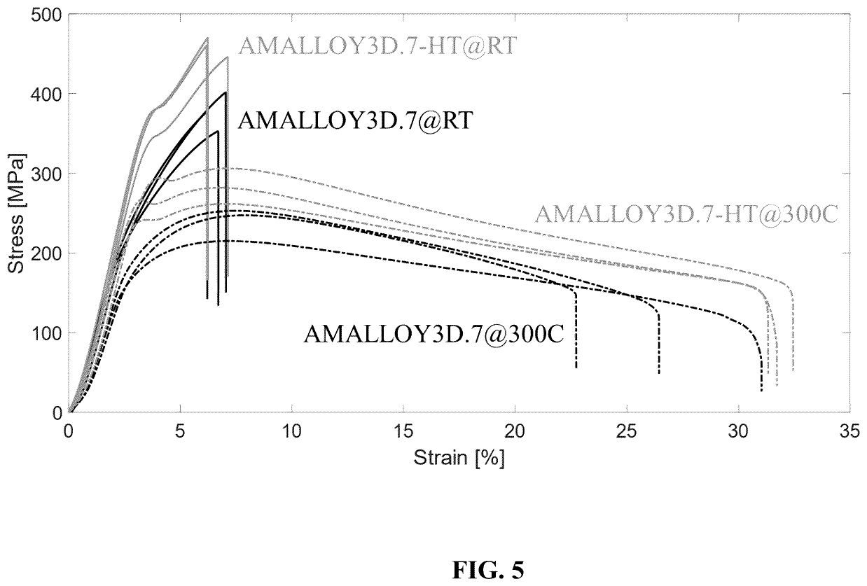

The results of tensile tests conducted at room temperature (RT) and up to 300° C. on the as-built AMALLOY3D.7-HT are reported in TABLE 5 and FIG. 5, comparing an alloy according to an embodiment of the present disclosure to AMALLOY3D.7. FIG. 5 is a graph of stress-strain tensile curves at room temperature and 300° C. of an alloy according to an embodiment of the present disclosure compared to an alloy which does not contain boron nitride nanoparticles. As shown in FIG. 5, three repetitions of stress-strain tensile curves were performed on AMALLOY3D.7-HT at room temperature (solid grey lines), AMALLOY3D.7 at room temperature (solid black lines), AMALLOY3D.7-HT at 300° C. (dashed grey lines), and AMALLOY3D.7 at 300° C. (dashed black lines).

At room temperature, AMALLOY3D.7-HT shows yield strength (YS) and ultimate tensile strength (UTS) higher than the AMALLOY3D.7 counterpart, with an increase of 39% and 10%, respectively, and almost no depletion in ductility. The nano-reinforcement coupled with the grain refinement induced by BN nanoparticles on the AMALLOY3D.7 matrix was believed to be important for boosting the yield strength value of AMALLOY3D.7-HT, which is 334 MPa at RT, without wishing to be bound by theory.

The increase of temperature in tensile tests up to 300° C. gradually reduced the tensile strength of AMALLOY3D.7-HT from 334 MPa down to 238 MPa whereas the ductility was greatly enhanced up to 31.8%. At 300° C., the elongation at failure of AMALLOY3D.7-HT applications is improved by about 3.9 times with respect to counterpart value at RT; the corresponding YS loss was about 28%.

At each tested temperature, the yield strength of AMALLOY3D.7-HT significantly exceeded the AMALLOY3D.7's counterpart values with relative increases of 58% at 160° C., 48% at 220° C., and 46% at 300° C.

TABLE 5

| | Testing | | | |
|---|---|---|---|---|
| Alloy | Temperature | YS | UTS | ε |
| grade | (° C.) | (MPa) | (MPa) | (%) |
| AMALLOY3D.7 | 25 | 239.5 ± 9.5 | 404.9 ± 5.8 | 6.6 ± 0.4 |
| | 160 | 204.6 ± 20.2 | 360.3 ± 48.6 | 9.9 ± 1 |
| | 220 | 211.1 ± 20 | 344 ± 19.9 | 13.9 ± 1.2 |
| | 300 | 163.9 ± 9.8 | 238.4 ± 20.4 | 26.7 ± 4.1 |
| AMALLOY3D.7- | 25 | 334.3 ± 20.7 | 447.4 ± 9.7 | 6.5 ± 0.5 |
| HT | 160 | 322.5 ± 9.3 | 431.2 ± 19.3 | 7.5 ± 0.7 |
| | 220 | 312.5 ± 47.8 | 390.3 ± 57.7 | 9 ± 1.5 |
| | 300 | 238.6 ± 15.4 | 267.6 ± 11.7 | 31.8 ± 0.6 |

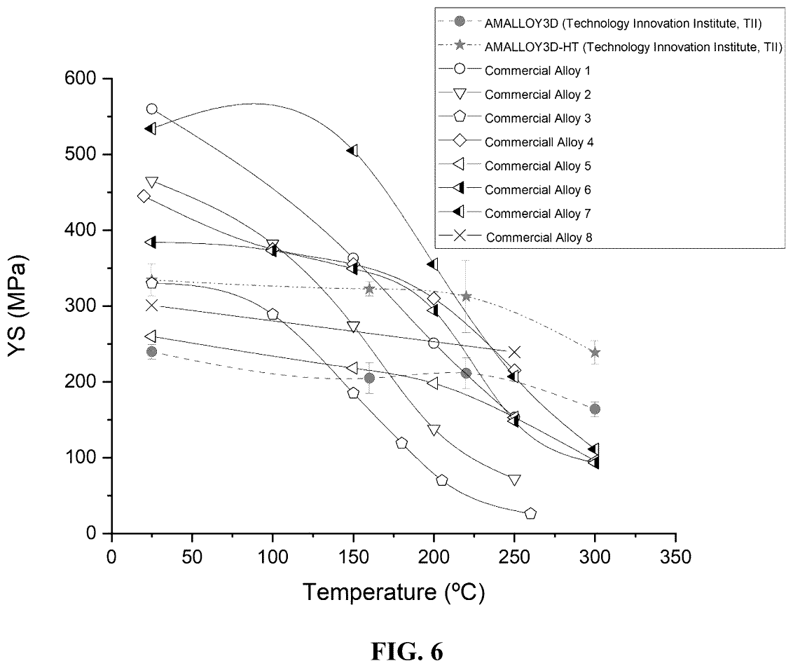

The temperature-dependent tensile properties of AMALLOY3D.7-HT, AMALLOY3D.7, and various commercially available alloys were compared in FIG. 6. FIG. 6 is a graph showing the relationship between yield strength and temperature of an alloy according to an embodiment of the present disclosure compared to an alloy which does not contain boron nitride nanoparticles and several commercially available alloys. AMALLOY3D.7 refers to the parent alloy containing copper (at 7 wt. %), silicon, iron, magnesium, and aluminum, and AMALLOY3D.7-HT refers to an alloy according to an embodiment of the present disclosure containing boron nitride nanoparticles and 7 wt. % copper.

As shown in FIG. 6, the strength gap between the alloys according to embodiments of the present disclosure and those available on the market is significantly reduced when increasing the temperature from 25° C. to 160° C. and to 220° C. At 220° C., AMALLOY3D.7-HT is comparable to or stands above many commercially available Al alloys. At 300° C., AMALLOY3D.7-HT surpasses the commercially available alloys. It is contemplated that the presence of Al₂Cu precipitates, which dissolve only at 540° C., contributes to this increase in stability, without wishing to be bound by theory. The additional presence of BN nanoparticles provides an extra increase of yield strength by grain refinement and dispersion strengthening, without wishing to be bound by theory, enabling the present alloy composition to reach extraordinary strength values at 250° C. and 300° C. The alloys according to embodiments of the present disclosure offer unique performance at high temperature compared to the products currently available on the market.

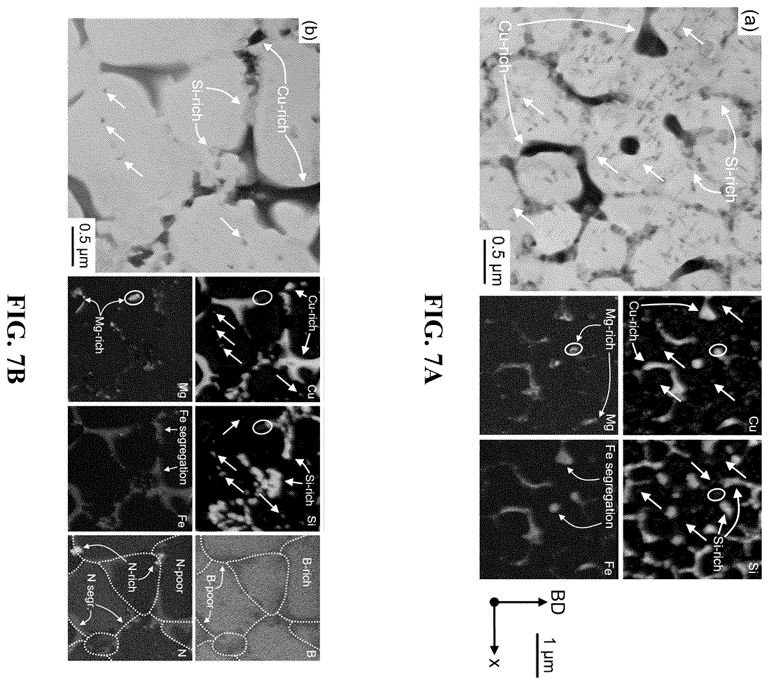

FIGS. 7A and 7B show bright field scanning transmission electron microscopy (BF-STEM) images and corresponding EDS maps of AMALLOY3D.7 in FIG. 7A and AMALLOY3D.7-HT which contains boron in FIG. 7B, according to an embodiment of the present disclosure. The solid arrows in the BF-STEM images and in the Cu and Si EDS maps indicate Cu— and Si—rich compounds found at the cell boundaries of AMALLOY3D.7, at the grain boundaries of AMALLOY3D.7-HT, and within these features for both alloys. Such phases are believed to be Al₂Cu and Si. Both AMALLOY3D.7 and AMALLOY3D.7-HT are characterized by the presence of Fe segregation at the cell/grain boundaries. In addition, it was observed that the presence of Mg-rich areas often paired with the presence of rich contents of both Si and Cu. These regions, highlighted by circles, may be related with the presence of the Al—Si—Cu—Mg compound also known as Q-phase. The dotted lines in the B and N EDS maps of AMALLOY3D.7-HT highlight the grain boundaries.

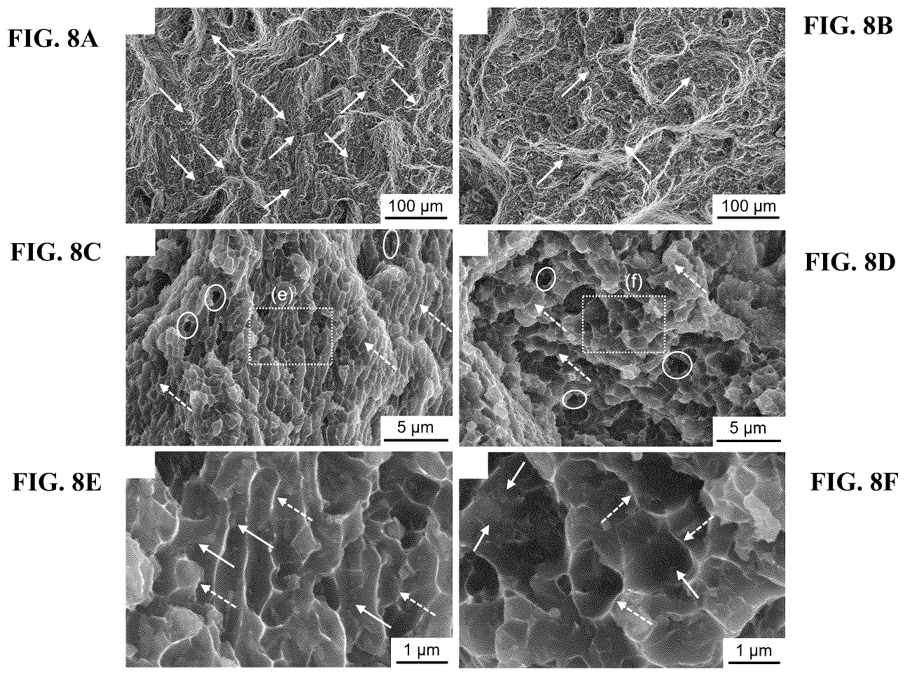

FIGS. 8A, 8C, and 8E show the fracture surface of AMALLOY3D.7 and FIGS. 8B, 8D, and 8F show the fracture surface of AMALLOY3D.7-HT which contains boron, according to an embodiment of the present disclosure. Solid arrows in FIGS. 8A and 8B point the presence of spherical micro-pores, dashed arrows in FIGS. 8C, 8D, 8E and 8F point the dimples, circles in FIGS. 8C and 8D highlight the presence of deep holes, and solid arrows in FIGS. 8E and 8F highlight the presence of nanosized precipitates. The fracture surface of AMALLOY3D.7, as seen in FIG. 8A, displayed significant macroscopic plastic deformation, with no cleavage planes observed. Moreover, the extensive presence of spherical micro-pores of around 5 to 10 μm, highlighted by the solid arrows, was noted. Some of these pores could be attributed to residual gas porosity present in the as-built samples. However, most of these pores were likely formed during loading by the heterogencity in grain morphology, observed in FIG. 3. During tensile testing, the fine equiaxed regions at melt pool boundaries were able to accommodate greater plastic deformation with respect to those in the melt pool core. As a result, the stress-triaxiality was promoted inducing the nucleation and coalescence of micro-pores. On the other hand, a considerably smaller number of spherical pores was detected on the fracture surface of AMALLOY3D.7-HT (FIG. 8B). These features are thought to be associated only with the residual gas porosities detected in the as-built microstructure (FIG. 2B). Therefore, owing to the fairly homogeneous grain morphology in AMALLOY3D.7-HT, limited micro-pore nucleation occurs during tensile loading. A closer look at the fracture surfaces of AMALLOY3D.7 and AMALLOY3D.7-HT is depicted in FIGS. 8C and 8D, respectively. The presence of deep holes highlighted by circles can be visible in both alloys. These could have arisen from brittle phases that pull-out of the Al-fcc matrix during tensile testing. Since these features have been consistently observed in both alloys, such stiff phases are thought to be either the Al₂Cu and/or Si compounds. The fracture surfaces depicted in FIGS. 8C and 8D show the extensive presence of dimples (highlighted by dashed arrows), features that further corroborate the ductile-like behavior of both alloys. The AMALLOY3D.7 alloy showed the presence of elongated dimples (FIG. 8E) with size and morphology similar to that of the cellular-dendritic substructures. On the other hand, slightly larger and highly globular dimples were observed on the fracture surface of AMALLOY3D.7-HT (FIG. 8F). These features have the size and morphology of the equiaxed grains depicted in FIG. 3 and FIG. 7B, and, therefore, the fracture is believed to occur at the grain boundaries. Both alloys showed the presence of nanosized precipitates within the dimples (highlighted by arrows). Their size and morphology could suggest that these compounds are Si particles, as observed in Al—Si—Cu alloys.

This disclosure is not limited to the particular systems, devices and methods described, as these may vary. The terminology used in the description is for the purpose of describing the particular versions or embodiments only and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A method for forming a three-dimensional article comprising an alloy, the method comprising steps of:
(a) depositing a first layer of a precursor powder onto a build platform, wherein the precursor powder comprises aluminum, silicon, copper, and boron;
(b) contacting the first layer of the precursor powder with an energy source to form a solid layer of the alloy;
(c) depositing a subsequent layer of the precursor powder on top of the solid layer; and
(d) contacting the subsequent layer of the precursor powder with the energy source to fuse the subsequent layer of the precursor powder to the solid layer;
thereby forming the three-dimensional article.

2. The method of claim 1, wherein the precursor powder comprises greater than or equal to 0.01 wt. % to less than or equal to 1 wt. % boron.

3. The method of claim 1, wherein the precursor powder comprises greater than or equal to 4 wt. % to less than or equal to 8 wt. % copper.

4. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 1 wt. % boron, and
greater than or equal to 75 wt. % to less than or equal to 88 wt. % aluminum.

5. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 1 wt. % boron,
greater than or equal to 0.01 wt. % to less than or equal to 0.5 wt. % nitrogen, and
greater than or equal to 75 wt. % to less than or equal to 88 wt. % aluminum.

6. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 1 wt. % boron,
greater than or equal to 0.01 wt. % to less than or equal to 0.8 wt. % iron, and
greater than or equal to 75 wt. % to less than or equal to 88 wt. % aluminum.

7. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 1 wt. % boron,
greater than or equal to 0.01 wt. % to less than or equal to 0.6 wt. % manganese, and
greater than or equal to 75 wt. % to less than or equal to 88 wt. % aluminum.

8. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 1 wt. % boron,
greater than or equal to 0.01 wt. % to less than or equal to 0.6 wt. % magnesium, and
greater than or equal to 75 wt. % to less than or equal to 88 wt. % aluminum.

9. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 1 wt. % boron,
greater than or equal to 0.01 wt. % to less than or equal to 0.3 wt. % titanium, and
greater than or equal to 75 wt. % to less than or equal to 88 wt. % aluminum.

10. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 1 wt. % boron,
greater than or equal to 0.01 wt. % to less than or equal to 0.5 wt. % nitrogen,
greater than or equal to 0.01 wt. % to less than or equal to 0.8 wt. % iron,
greater than or equal to 0.01 wt. % to less than or equal to 0.6 wt. % manganese,
greater than or equal to 0.01 wt. % to less than or equal to 0.6 wt. % magnesium,
greater than or equal to 0.01 wt. % to less than or equal to 0.3 wt. % titanium, and
greater than or equal to 75 wt. % to less than or equal to 88 wt. % aluminum.

11. The method of claim 1, further comprising preparing the precursor powder, wherein preparing the precursor powder comprises combining a copper-containing powder with a silicon-containing powder and boron.

12. The method of claim 1, further comprising preparing the precursor powder, wherein preparing the precursor powder comprises combining boron, an elemental copper powder, and a pre-alloyed powder comprising silicon and aluminum.

13. The method of claim 1, further comprising preparing the precursor powder, wherein preparing the precursor powder comprises sizing the precursor powder to an average particle size of greater than or equal to 1 μm to less than or equal to 65 μm.

14. The method of claim 1, further comprising preparing the precursor powder, wherein preparing the precursor powder comprises sizing the precursor powder to a particle size distribution of 1 μm to 65 μm.

15. The method of claim 1, further comprising preparing the precursor powder, wherein preparing the precursor powder comprises mixing the precursor powder via ball milling, sizing the precursor powder via vibratory sieving, or a combination thereof.

16. The method of claim 1, further comprising (e) repeating steps (c) through (d) a plurality of times.

17. The method of claim 1, wherein the three-dimensional article has a density of greater than or equal to 99.2%.

18. The method of claim 1, wherein the three-dimensional article has a density of greater than or equal to 99.5%.

19. The method of claim 1, wherein the three-dimensional article has a density of greater than or equal to 99.9%.

20. The method of claim 1, wherein the alloy has a yield strength of greater than or equal to 200 MPa at 300° C., an ultimate tensile strength of greater than or equal to 250 MPa at 300° C., and a density of greater than or equal to 99.2%.

21. A method for producing an alloy structure having a density of greater than or equal to 99.2%, comprising:
providing a precursor powder comprising greater than or equal to 4 wt. % to less than or equal to 8 wt. % copper and greater than or equal to 0.01 wt. % to less than or equal to 1 wt. % boron to an additive manufacturing system; and
contacting the precursor powder with an energy source to form the alloy structure.

22. An alloy, comprising:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 1 wt. % boron, and
greater than or equal to 75 wt. % to less than or equal to 88 wt. % aluminum,
wherein the alloy has a yield strength of greater than or equal to 200 MPa at 300° C., an ultimate tensile strength of greater than or equal to 250 MPa at 300° C., and a density of greater than or equal to 99.2%.
